(19) United States
(12) Patent Application Publication
(10) Pub. No.: US 2020/0205411 A1
(43) Pub. Date: Jul. 2, 2020

(54) PLANT GROWTH REGULATOR AND FUNGICIDE

(71) Applicant: FINE AGROCHEMICALS LIMITED, WHITTINGTON (GB)

(72) Inventors: Philip Simon WIKELEY, MALVERN (GB); Joëlle REIGNARD, MEYZIEU (FR); Wim AELBRECHT, OPWIJK (BE)

(73) Assignee: FINE AGROCHEMICALS LIMITED, WHITTINGTON (GB)

(21) Appl. No.: 16/621,712

(22) PCT Filed: Jun. 12, 2018
(86) PCT No.: PCT/EP2018/065513

§ 371 Date: Dec. 12, 2019

(30) Foreign Application Priority Data
Jun. 12, 2017 (EP) 17175541.6

(51) Int. Cl. A01N 43/653; A01N 37/42; A01N 25/04

(52) U.S. Cl. CPC A01N 43/653; A01N 25/04; A01N 37/42

(57) ABSTRACT

The invention relates to a water based spraying liquid suitable for spraying plants, wherein the liquid comprises water and a suitable amount of the plant growth regulator prohexadione optionally in combination with trinexapac-ethyl, and a fungicide chosen from the group of prothioconazole, metconazole, difenoconazole, paclobutrazole, triticonazole, tebuconazole, azoxystrobin, picoxystrobin, boscalid and penthiopyrad, wherein the amount of growth regulator is between 20 and 400 g per hectare and wherein the amount of fungicide is between 20 and 500 g/ha. Preferably, the growth regulator is prohexadione-calcium, and the fungicide is prothioconazole.

### FIELD OF THE INVENTION

The invention relates to a combination of a growth regulator and a fungicide in a method to treat plants. Such growth regulator is commonly noted as plant growth regulator, or PGR. The invention also relates to a kit of parts and a concentrate comprising the both compounds for use in agriculture. Furthermore, the invention relates to use of said plant growth regulator and fungicide in crops, preferably broad acre crops like rape seed oil crop and cereal crops.

### BACKGROUND OF THE INVENTION

In many horticultural and agricultural applications, plant growth regulators (growth inhibitors or growth stimulants) are applied for a variety of reasons. For example, it can be useful to increase the speed of growth, increase root formation, seedling setting and the like. It may also be useful to reduce growth in order to have short stems in grain culturing, reduce seed formation in citrus fruits and the like.

In many horticultural and agricultural applications, fungicides are regularly applied, in order to combat diseases caused by fungi.

Many of the growth regulators, insecticides, fungicides, herbicides and the like are applied on the crop by spraying in a diluted solution in water.

Generally, the farmer appreciates to use concentrated products, like liquid formulations that can easily be admixed with water to result in homogeneous mixtures without additional process steps. Furthermore, often, a farmer wants to apply several active compounds in one spray run. Hence, active compounds are generally supplied as concentrated liquids.

CN103814901 and WO2015//024995 for example suggest to combine prohexadion with fungicides or other active compounds in agricultural treatments.

NZ566983 describes a combination of epoxiconazole with trinexapac, that is suggested to have a synergistic fungicidal effect

It would be preferred to use a plant growth regulator and a fungicide that enhances the growth regulatory activity.

It is therefore an object of the invention to provide a combination of a growth regulator and a fungicide with enhanced efficacy for agricultural use.

It is furthermore an object of the invention to provide a use of the inventive combination on certain crops.

It is furthermore an object of the invention to provide an efficient formulation of said combination.

It is furthermore an object of the invention to provide a kit of parts for use in said combination.

### SUMMARY OF THE INVENTION

The first object of the invention is provided with a water based spraying liquid suitable for spraying plants, wherein the liquid comprises water and a suitable amount of the plant growth regulator prohexadione, optionally in combination with trinexapac-ethyl, and at least one fungicide chosen from the group consisting of prothioconazole, metconazole, difenoconazole, paclobutrazole, triticonazole, tebuconazole, azoxystrobin, picoxystrobin, boscalid and penthiopyrad, wherein the amount of plant growth regulator is between 20 and 300 gram per hectare, and wherein the amount of fungicide is between 20 and 500 gram per hectare.

For second objective, a method is provided for treating plants with the plant growth regulator prohexadione, optionally combined with trinexapac-ethyl, and at least one fungicide, wherein a water based spraying liquid as defined in the preceding paragraph is sprayed on plants in an amount of about 80 L to about 500 L per hectare.

The plants are preferably broad acre crop chosen from rape or cereal, and if the crop is cereal, preferably, the cereal is chosen from barley, oat, wheat, rye, triticale, grain or corn.

Preferably, the growth regulator comprises prohexadione-calcium.

Preferably for rape seed type crop, prohexadione-calcium is used as growth regulator.

In another embodiment, in particular relating to gramineae (cereal crop), a combination of growth regulators (prohexadione and trinexapac) is used, in combination with at least one fungicide. The relative amounts of prohexadione and trinexapac preferably are about 1:5 to 5:1.

In one preferred embodiment, the fungicide is chosen from a group of fungicides that shows little or no plant regulatory effect. This group comprises prothioconazole, azoxystrobin, picoxystrobin, boscalid and penthiopyrad, of which the most preferred fungicide is prothioconazole.

In another preferred embodiment, at least one fungicide is used comprising a triazole ring and having some plant growth regulatory effect, which group consists of metconazole, difenoconazole, paclobutrazole, triticonazole and tebuconazole.

For achieving the third objective, a liquid dispersion is provided comprising:
the plant growth regulator prohexadione, optionally in combination with trinexapac-ethyl;
at least one fungicide chosen from the group comprising prothioconazole, metconazole, difenoconazole, paclobutrazole, triticonazole, tebuconazole, azoxystrobin, picoxystrobin, boscalid and penthiopyrad;
an organic hydrophobic carrier chosen from a vegetable oil;
wherein more than about 90% of the particles of said growth regulator and said fungicide have a particle size of between 1-7 μm;
wherein the dispersion further comprises an emulsifier which stabilizes the dispersion in the organic carrier, and wherein the emulsifier is non-ionic, and comprises at least one fatty acid group, at least one polyethoxy group, or more than one ethoxy group, and at least one polyol, wherein the fatty acid and polyol may be combined in hydroxyl-fatty acid;
at least one additive to reduce settling
wherein the dispersion is essentially water free.

Preferably, the growth regulator comprises prohexadione-Ca salt and the fungicide comprises prothioconazole.

The fourth objective is achieved by providing a kit of parts for use in the method of the present invention, wherein prohexadione is provided in a first concentrated form, and the fungicide is provided in a second concentrated form, wherein the relative amounts of actives in the kit are adapted to provide the amounts described in accordance with the present invention, for example by instructions how to use both compounds in the method according to the present invention.

Apart from the kit-of parts and the oil-dispersion according the third and fourth objective, the two or more actives may be supplied separately, or together in one formulation. Several types of formulations exist, and for example granules having at least two actives are suitable for the invention. Yet, the oil dispersion is preferred because of the much faster mixing characteristics.

Unexpectedly, the combination of prohexadione that acts on the gibberilic acid pathway by virtue of mimicking 2-glutaric acid (and thereby interfering with the late steps of GA synthesis), combined with a fungicide being an inhibitor of a sterol biosynthesis such as prothioconazole or the other listed triazole fungicides, metconazole, difenoconazole, paclobutrazole, triticonazole, tebuconazole, or azoxystrobin, picoxystrobin, boscalid or penthiopyrad show a synergistic effect in length retardation, and thereby allowing more energy in the plants to be used for leaves and seeds as enhanced growth control leads to less lodging and less risk of losing yield.

In one embodiment of the invention, the at least two actives are supplied to a farmer in separate concentrated products. In this embodiment, the at least two actives preferably are provided as kit of parts.

In another embodiment, the two actives are supplied in one formulation, simplifying the application by the farmer. The one formulation can take several forms, such as dispersible or dissolvable granules, liquid dispersion, solutions and the like. Preferably, the formulation is a liquid, oil based dispersion.

The fungicide can be obtained and used in their commercially available form, if not provided in a combination product with the growth regulator.

The invention further relates to the use of a fungicide chosen from the group consisting of prothioconazole, metconazole, difenoconazole, paclobutrazole, triticonazole, tebuconazole, azoxystrobin, picoxystrobin, boscalid and penthiopyrad to enhance the growth regulation effect of prohexadione, optionally combined with trinexapac-ethyl.

### DETAILED DESCRIPTION OF THE INVENTION

The invention provides water based spraying liquid suitable for spraying plants, wherein the liquid comprises water and a suitable amount of the plant growth regulator prohexadione, optionally combined with trinexapac-ethyl, and at least one fungicide chosen from the group of prothioconazole, metconazole, difenoconazole, paclobutrazole, triticonazole, tebuconazole, azoxystrobin, picoxystrobin, boscalid and penthiopyrad, wherein the amount of growth regulator is between 20 and 400 g per hectare and wherein the amount of fungicide is between 20 and 500 g/ha.

Preferably, the growth regulator comprises prohexadione-calcium.

Preferably for rape seed type crop, prohexadione-calcium is used as growth regulator.

In another embodiment, in particular relating to gramineae (cereal crop), a combination of both growth regulators (prohexadion and trinexapac) is used, in combination with at least one fungicide. The two growth regulators preferably are used in a ratio between about 1:5 to 5:1 on weight basis.

As fungicides for use with the combination of prohexadione and trinexapac, preferably prothioconazole and/or bosccalid, penthiopyrad or fluxapyroxad used. This is in particular effective for control of Septoria fungi.

In one preferred embodiment, the fungicide is chosen from a group of fungicides that shows little or no plant regulatory effect. This group comprises prothioconazole, azoxystrobin, picoxystrobin, boscalid and penthiopyrad, of which the most preferred fungicide is prothioconazole.

In another preferred embodiment, at least one fungicide is used comprising a triazole ring and having some plant growth regulatory effect, which group consists of metconazole, difenoconazole, paclobutrazole, triticonazole and tebuconazole.

Prohexadione (mostly used as prohexadione-Ca-salt) can be supplied as granules, as for example described in WO2011/012495. Preferably, prohexadione-Ca-salt is used as a liquid, oil based dispersion, as described in WO2015/024995.

In a further preferred embodiment, at least two fungicides are combined with the prohexadione optionally combined with trinexapac-ethyl plant growth regulator, wherein the fungicide comprises prothioconazole and at least one of metconazole, difenoconazole, paclobutrazole, triticonazole, tebuconazole, azoxystrobin, picoxystrobin, boscalid and penthiopyrad. In this embodiment, the total amount of fungicide preferably remains below 500 g/ha.

The fungicides can be supplied as dispersion concentrates or other forms, commercially available.

Preferably, the growth regulator is applied in an amount between 50 and 200 g per hectare and the fungicide is applied in an amount of between 30 and 300 g/ha.

In a preferred embodiment, the ratio between the growth regulator and the fungicide is between 1:0.6 to 1:4, preferably 1:1 to 1:3.

As shown in the examples, the combination of the growth regulator and fungicide provides for an unexpected reduction in stem length. Hence, the invention in particular provides a water based spraying liquid, wherein the amounts of growth regulator and fungicide are such that a synergistic effect on stem length retardation is achieved.

The spraying liquid according to the invention may contain further additionally, one or more plant growth regulators, fungicides, metal compounds, penetrating agents and/or one or more jasmonates.

In a preferred embodiment, the spraying liquid comprises additional active compounds or additives. For example, such additional active compound may be stable and soluble in water and is preferably delivered to the farmer as concentrated solution in water. Hence, additives or additional active components, to be used in combination with the growth regulator and the fungicide can be added directly to the water phase.

In case a prohexadione salt is used as plant growth regulator, an ammonium salt such as for example ammoniumsulphate, and an acid such as for example a carboxylic acid, such as for example citric acid, adipic acid, acetic acid or the like can be added to the water phase, instead of being part of the oil dispersion.

The spraying liquid of the invention preferably also comprises emulsifiers and the like, penetration enhancers etc., like for example an aliphatic amine compound, such as for example N,N-dimethyl decanamide or N-decyl-N-methyl-formamide. The amount of penetration enhancer can be about 0.3 to 20 times the amount of active components (growth regulator plus fungicide), preferably 1-5 times the amount of active components.

The spraying liquid according to the present invention may further comprise additional growth regulators (plant growth regulators). Preferred additional growth regulators include one or more of chlormequat, ethephon, mepiquat, gibberellins, an auxin and/or cytokinin.

Suitable auxins include natural or synthetic chemicals that behave like the naturally occurring auxins produced by plant enzyme systems, and the term “auxin” and “auxins” as used herein refers to such compounds in natural and synthetic form. Indoleacetic acids, indol-3-butyric acid (3-BA); naphthaleneacetamide; 2 methyl-1-naphthaleneacetic acid and 2-methyl-1-naphthylacetamide have hormonal activity and may be substituted for the naturally occurring auxins. It may be useful to have metal ions present with the auxins, such as for example zinc or manganese. In preferred embodiments, the auxin employed is selected from the group consisting of 3-indolebutyric acid, 3-indoleacetic acid, 1-naphthylacetic acid, 3-indolebutyric acid, and salts and esters thereof. Preferably, the metal ions required for a good activity are supplied together with the auxin.

Suitable cytokinins are a class of plant regulation substances (phytohormones) that promote cell division, or cytokinesis, in plant roots and shoots. There are two types of cytokinins: adenine-type cytokinins represented by kinetin, zeatin, and 6-benzylaminopurine (also referred to as BAP, 6-BAP, or 6-benzyladenine), and phenylurea-type cytokinins like diphenylurea and thidiazuron (TDZ). In preferred embodiments the cytokinin is selected from the group consisting of kinetin (synthetic or derived from seaweed), 6-BAP, 1-(2-chloropyridin-4-yl)-3-phenylurea (CPPU), and TDZ. Suitable additional compounds include specific anti powdery mildew fungicides such as morfolines like fenpropidine and fenpropimorf, metrafenone, cyflufenamide, quinoxyfen and proquinazid; SBI fungicides like triazoles like epoxyconazol, etc, other than the ones mentioned above; Strobilurines (Qol fungicides) like coumoxystrobin, dimoxystrobin, enoxastrobin, famoxadone, fenamidone, fenaminostrobin, fluoxastrobin, flufenoxystrobin, kresoxim-methyl, metominostrobin, orysastrobin, pyraoxystrobin, pyraclostrobin, pyrametastrobin, pyribencarb, triclopyricarb trifloxystrobin and SDHI like fungicides like benodanil, bixafen, carboxin, fenfuram, fluopyram, flutolanil, fluxapyroxad, furametpyr, isopyrazam, mepronil, oxycarboxin, penflufen, penthiopyrad, sedaxane and thifluzamid.

Suitable further compounds that can be added are jasmonates or phosphonic acid, which strengthen the defence mechanisms of the plants. Suitable jasmonates include methyl jasmonate, propyldihydrojasmoante and jasmonic acid.

Suitable further compounds that can be added are metal compounds, such as for example zinc, manganese, selenium, iron copper, boron, molybdenum, and magnesium and the like. The metal ions can be used as chelates or salts, like for example EDTA chelates, citrate salts, proteinates or otherwise in a form that the metals are absorbed by the plant leafs.

The spraying liquid preferably is used in a method for treating plants with said plant growth regulator and said at least one fungicide, wherein a water based spraying liquid according to the invention is sprayed on plants in an amount of about 80 L to about 500 L per hectare, preferably about 100 L to 400 L per hectare.

Preferably, the spraying liquid according the invention is used on broad acre crop chosen from rape or cereal. If the crop is cereal, the cereal is preferably chosen from barley, oat, wheat, rye, triticale, grain or corn.

The invention is also providing a kit of parts suitable for preparing the spraying liquid of the invention, wherein the plant growth regulator (prohexadione) is provided in a first concentrated form, and the fungicide is provided in a second concentrated form, wherein the relative amounts of actives in the kit is adapted to provide the amounts described above, for example by instructions how to use both compounds in the method according to the present invention.

The invention also provides a composition, preferably granular composition, comprising
as plant growth regulator, prohexadione, optionally in combination with trinexapac-ethyl;
at least one fungicide chosen from the group comprising prothioconazole, metconazole, difenoconazole, paclobutrazole, triticonazole, tebuconazole, azoxystrobin, picoxystrobin, boscalid and penthiopyrad
wherein the amount of said growth regulator is about 4 wt % or more and about 50 wt % or less, and the amount of fungicide is about 2 wt % or more and about 50 wt % or less
optionally at least one of a binder, a dispersion agent, and anticacking agent.

Such a composition is a convenient way to provide the at least both actives together. Many formulations for liquid or solid compositions are known. Granular compositions are for example described in WO2002/829902 and WO2015/038917.

In a preferred embodiment, the invention provide a liquid dispersion comprising:
as plant growth regulator, prohexadione, optionally combined with trinexapac-ethyl;
at least one fungicide chosen from the group comprising prothioconazole, metconazole, difenoconazole, paclobutrazole, triticonazole, tebuconazole, azoxystrobin, picoxystrobin, boscalid and penthiopyrad;
an organic hydrophobic carrier chosen from a vegetable oil;
wherein more than about 90% of the particles of said growth regulator have a particle size of between 1-7 μm;
wherein the fungicide is dissolved or dispersed in the liquid, and if dispersed has a particle size of between 1-7 μm;
wherein the dispersion further comprises an emulsifier which stabilizes the dispersion in the organic carrier, and wherein the emulsifier is non-ionic, and comprises at least one fatty acid group, at least one polyethoxy group, or more than one ethoxy group, and at least one polyol, wherein the fatty acid and polyol may be combined in hydroxyl-fatty acid;
at least one additive to reduce settling
wherein the dispersion is essentially water free.

Preferably, this dispersion comprises prohexadione-Ca salt as growth regulator and prothioconazole as the fungicide.

Preferably, the dispersion comprises an amount of said growth regulator of about 4 wt % or more and about 40 wt % or less, and the amount of fungicide of about 2 wt % or more and about 40 wt % or less.

The dispersed particles generally have a small particle size. Generally, more than 90% of the particles of said growth regulator will have a particle size of about 1-7 μm or less, preferably about 5 μm or less.

The fungicide can be dissolved or dispersed in the oil based carrier. For example, prothioconazole is soluble in the vegetable oil, while for example boscalid would not be soluble, and therefore preferably would be in solid form, with a particle size of about 1-7 μm.

The dispersion further comprises an emulsifier which stabilizes the dispersion in the organic hydrophobic carrier (hereinafter also the oil dispersion), and which causes the concentrate to be water miscible and self-emulsifying when diluted in a suitable dilution in water. A suitable dilution is the dilution in which the dispersion will be used in practice. For testing purposes, it may be adequate to use for example a 1:50 dilution.

The emulsifier has several roles. The influence on the stability of the oil dispersion can be assessed by storage stability tests of the concentrate. The self-emulsifying property of the oil dispersion can be tested by adding a suitable amount of dispersion in water. For example, one could add 1 wt % of oil dispersion to water, and invert the vessel with the mixture a few times (i.e., turning the vessel upside down). Generally, a stable emulsion should have been formed when 8 times turning the vessel upside down, or less. Preferably, the dispersion is emulsified in water with inverting the vessel 4 times or less, preferably about two times or less. The precise structure of the emulsion in water is not so important, as long as the at least one active ingredient is well dispersed, and the mixture is stable. Generally, at least the oil forms an emulsion in the water phase. The at least one active may be dispersed, or dissolved in the water phase, and/or may be present in the oil as particles. Furthermore, the emulsifier may act as an adjuvant, promoting the uptake of the active ingredient into the plant.

The preferred dispersion is essentially water free, which means that preferably the oil dispersion contains less than about 0.4 wt % water, more preferably about 0.2 wt % or less, as can be measured with Karl Fisher titration.

The preferred dispersion according the invention preferably comprises prohexadione optionally in combination with trinexapac-ethyl as the growth regulator.

Prohexadione can be used as free base or ester, but is generally used as salt. A preferred salt is prohexadione-calcium. A prohexadione salt like the preferred prohexadione Ca preferably is present in an amount of about 4 wt % or more, preferably about 5 wt % or more. Generally, the amount will be about 40 wt % or less preferably about 30 wt % or less, more preferably about 20 wt % or less. Suitable amounts include about 10 wt % or less, like for example about 8 wt % or less.

The preferred dispersion according the invention, if the composition comprises prohexadione Ca salt as the growth regulator, preferably comprises additionally an ammonium compound, such as for example ammonium nitrate, ammonium propionate, ammonium sulphate, or ammonium phosphate, preferably ammoniumsulphate. The ammonium sequestrates the calcium ion, which otherwise may hamper the uptake of the growth regulator by the plant. A cationic emulsifier, such as those described below, can also be used as ammonium compound.

The preferred dispersion according the invention furthermore, preferably comprises an acidifier, such as preferably an organic acid, like preferably citric acid, adipic acid or acetic acid.

The preferred dispersion of the invention preferably also comprises an aliphatic amine compound, such as for example N,N-dimethyl decanamide or N-decyl-N-methyl-formamide. Such amine compounds preferably are present in an amount between 5 and 25 wt % of the dispersion, more preferably between 10 and 25 wt %.

These salts and/or acids and/or amine compounds may be dispersed or dissolved in the oil phase according to their solubility properties.

The dispersion according to the present invention may further comprise additional growth regulators (to be understood as plant growth regulators). Preferred additional growth regulators (apart from, and next to trinexepac-ethyl) include one or more of chlormequat, ethephon, mepiquat, gibberellins, an auxin and/or cytokinin.

Suitable auxins include natural or synthetic chemicals that behave like the naturally occurring auxins produced by plant enzyme systems, and the term “auxin” and “auxins” as used herein refers to such compounds in natural and synthetic form. Indoleacetic acids, indol-3-butyric acid (3-BA); naphthaleneacetamide; 2 methyl-1-naphthaleneacetic acid and 2-methyl-1-naphthylacetamide have hormonal activity and may be substituted for the naturally occurring auxins. It may be useful to have metal ions present with the auxins, such as for example zinc or manganese. In preferred embodiments, the auxin employed is selected from the group consisting of 3-indolebutyric acid, 3-indoleacetic acid, 1-naphthylacetic acid, 3-indolebutyric acid, and salts and esters thereof. Preferably, the metal ions required for a good activity are supplied together with the auxin.

Suitable cytokinins are a class of plant regulation substances (phytohormones) that promote cell division, or cytokinesis, in plant roots and shoots. There are two types of cytokinins: adenine-type cytokinins represented by kinetin, zeatin, and 6-benzylaminopurine (also referred to as BAP, 6-BAP, or 6-benzyladenine), and phenylurea-type cytokinins like diphenylurea and thidiazuron (TDZ). In preferred embodiments the cytokinin is selected from the group consisting of kinetin (synthetic or derived from seaweed), 6-BAP, 1-(2-chloropyridin-4-yl)-3-phenylurea (CPPU), and TDZ.

Preferably, the carrier material is a vegetable oil with a melting point of about 10° C. or lower, preferably of about 0° C. or lower. Suitable vegetable oils are e.g. palm oil, soybean oil, rapeseed oil, sunflower oil, cotton seed oil, palm kernel oil, coconut oil, linseed oil, olive oil, peanut oil and the like. Suitable derivatives of vegetable oils include alkyl esters of the fatty acids, like for example C₁-C₆-alkyl esters, like for example bio-diesel, or methyl esters of rape seed oil and the like.

The dispersion according to the invention contains an emulsifier as an important ingredient. The emulsifier acts as a dispersant to enhance the dispersibility of the insoluble particles of the growth regulator initially and to enhance the storage stability of the dispersion. The emulsifier also aids in the dispersion of the growth regulator particles on dilution in water and thirdly the emulsifier aids in the emulsification of the carrier fluid in the water phase.

Preferably, the emulsifier is an alkoxylated sugar, preferably esterified with fatty acids. Suitable sugars, or polyols, are pentaeritritol, sorbitol, maltose, trimethylolpropane, ethyleneglycol and the like. The alkoxygroups preferably are ethyloxy or propyloxy, and most preferably at least comprise at least 3 ethoxy groups, preferably at least 5 ethoxy groups. Esterification with fatty acids may comprise esterification with C₁₂-C₂₄ fatty acids, wherein the fatty acids may be unsaturated, and preferably are monounsaturated. The inventors have found the ethoxylated sorbitans to be most preferred emulsifiers. Examples of such ethoxylated esterified sorbitans are Atlas G 1086, Atlas G 1096, Arlatone TV. Further suitable dispersants are Atlox 4912, Atlox 4914 and Atlox LP-1, which comprise ethoxylated polyhydroxystearic acid, copolymers of fatty acid. Further suitable emulsifiers include alcohol-alkylene oxide addition products, such as tridecyl alcohol-C16 ethoxylate; ethoxylated fatty acids such as castor oil ethoxylate (EO 25 or 40) and polyethylene glycol esters of fatty acids, such as polyethyleneglycol stearate.

Hence, the preferred emulsifier is non-ionic, and comprises at least one fatty acid group, at least one polyethoxy group, or more than one ethoxy group, and at least one polyol (diol, triol or higher alcohol), wherein the fatty acid and polyol may be combined in hydroxyl-fatty acid.

It may be useful to use more than one emulsifier. Suitable additional emulsifiers are anionic, cationic or further nonionic emulsifiers.

Typical emulsifiers, or surface-active agents, are alkyl sulphate salts, such as diethanol ammoniumlaurate sulphate, alkylarylsulphonate salts, such as like calcium dodecyl benzene sulphonate, alkylphenol-alkylene oxide addition products, such as nonylphenol-C18 ethoxylate; alcohol-alkylene oxide addition products, such as tridecyl alcohol-C16 ethoxylate; ethoxylated fatty acids such as castor oil ethoxylate (EO 25 or 40), soaps such as sodium stearate; alkylnaphthalene-sulphonate salts such as sodium dibutylnaphthalenesulphonate; dialkylesters of sulphosuccinate salts, such as sodium di(2-ethylhexyl) sulpho-succinate; sorbitol esters such as sorbitol oleate; quaternary amines, such as lauryl trimethylammonium chloride; polyethylene glycol esters of fatty acids, such as polyethyleneglycol stearate; block-copolymers of ethyleneoxide and propylenenoxide; salts of mono and dialkyl phosphate esters; polyamine-fatty acid condensates; random polyester condensates; lecitine or modified lecitines; mono- or di-glycerides and the like.

The amount of emulsifier is generally about 10 wt % or more, preferably about 15 wt % or more. Generally, the amount will be about 30 wt % or less. Suitable amounts include about 18 wt %, about 20 wt % or about 22 wt %. The amount is the total amount of the combined emulsifiers.

The dispersion according the invention may comprise further components, such as for example at least one of a further growth regulator, a fungicide, an anti-settling agent, an antioxidant, a biocide, an antifoam, a metal compound, or another additive known in the art like safeners, colorants and the like.

The dispersion according to the present invention may further comprise a fungicide other than the fungicide already present. Preferably, one or more of the following fungicides is used: Specific anti powdery mildew fungicides such asmorfolines like fenpropidine and fenpropimorf, metrafenone, cyflufenamide, quinoxyfen and proquinazid; SBI fungicides like triazoles like epoxyconazol; Strobilurines (Qol fungicides) like coumoxystrobin, dimoxystrobin, enoxastrobin, famoxadone, fenamidone, fenaminostrobin, fluoxastrobin, flufenoxystrobin, kresoxim-methyl, metominostrobin, orysastrobin, pyraoxystrobin, pyraclostrobin, pyrametastrobin, pyribencarb, triclopyricarb trifloxystrobin and SDHI like fungicides like benodanil, bixafen, carboxin, fenfuram, fluopyram, flutolanil, fluxapyroxad, furametpyr, isopyrazam, mepronil, oxycarboxin, penflufen, penthiopyrad, sedaxane and thifluzamid.

Suitable further compounds that can be added are jasmonates or phoshonic acid, which strengthen the defence mechanisms of the plants. Suitable jasmonates include methyl jasmonate, propyldihydrojasmoante and jasmonic acid.

Suitable further compounds that can be added are metal compounds, such as for example zinc, manganese, selenium, iron copper, boron, molybdenum, and magnesium and the like. The metal ions can be used as chelates or salts, like for example EDTA chelates, citrate salts, proteinates or otherwise in a form that the metals are absorbed by the plant leafs.

The dispersion according to the present invention further comprises at least one additive to reduce settling. Preferred anti-settling agents include silica (like fumed silica) or clay (like bentonite). The amount of anti-settling agent preferably is about 5 wt % or less, preferably about 3 wt % or less, and even more preferred, about 2 wt % or less, like for example about 1 wt %. Other anti-settling agents include polymers, like for example polyester block copolymers or polyamides, such as for example Atlox Rheostrux type polymers. These additives to reduce settling are generally used in an amount of about 10 wt % or less, preferably about 5 wt % or less and can be e.g. 3 wt % or less. The additive will generally be used in an amount of about 0.3 wt % or more, like for example about 0.5 wt % or more, and more preferably about 1 wt % or more.

The dispersion according the invention may further include an anti-oxidant, such as for example vitamin-E, butylated hydroxyanisole, Vulkanox BHT (2,6-di-tert.-butyl-p-cresol) or butylhydroxytoluene.

The dispersion of the invention may further include an antifoam such as silicone based oils, magnesium stearate or octanol.

The dispersion according the invention may further include a biocide, like a bactericide and/or algicide, like for example isothiazolin-3 derivatives, like benzyl-isothiazolin, n-octyl isothiazolinone, chloro-methyl and methyl isothiazolinone; bromo-nitro-propane-diol; ethylenedioxydimethanol; (3-(3,4-dichlorophenyl)-1,1-dimethylurea; iodo-propynyl butyl carbamate; N-trichloromethylthiophtalimide; Zinc Pyrithione; dichlorophen, streptomycin, coppersulphate, or sorbate.

The further compounds—if solids—may be micronized, or may be used as larger particle sizes. Preferably, the particle size of all the solid components in the oil dispersion is about 30 μm or less, more preferably, about 20 μm or less, and even more preferably, about 12 μm or less, and most preferably between about 1-7 μm.

The dispersion as described above is suitable to be diluted to obtain a water based spraying liquid for spraying plants.

Such water based spraying liquid comprises water and a suitable amount of dispersion. Further, other additives, actives etc. may be present, which can be separately mixed with the water.

A suitable dilution comprises about 96 wt % water or more and about 4 wt % of said dispersion or less. Preferably, the dispersion is diluted with water in a range of about 1:50 to 1:200 (in volume/volume). Suitable amounts of dispersion in water include 1 wt %, 1.25 wt % and 1.5 wt %.

The plants are preferably broad acre crop chosen from rape (Brassic napus) or cereal, and if the crop is cereal, the cereal is chosen from barley, oat, wheat, rye, triticale, grain or corn.

Preferred crop plants belong to the plant genus Brassica include; Brassica napus comprising winter rapeseed, summer rapeseed, and several mustard species. Brassica napus is most preferred.

### Examples A-D and 1-2

In the following examples, FAL2023 was used, comprising 5 wt % prohexadione-Ca as active ingredient in an oil based dispersion, and prepared in accordance with WO-2015/024995. As the prothioconazole, Joao (from Bayer Crop Science was used, which is an emulsifiable concentrate having 25 wt % active.

Rape seed was sprayed with a volume of 200 L/hectare, on 10 March, when the height was on average 6.8 cm, with compounds as shown in the following table. The table also includes the results.

| | Example | | | | | |
|---|---|---|---|---|---|---|
| Treatment | A | B | C | 1 | D | 2 |
| Prohexadion-Ca (g/ha) | — | 75 | — | 75 | 50 | 50 |
| Prothioconazol (g/ha) | — | — | 175 | 175 | — | 175 |
| Height at 4 April (cm) | 65 | 58.3 | 62.3 | 53.5 | 61.8 | 58.5 |
| Length reduction (cm) | | 6.7 | 2.7 | 11.5 | 3.2 | 6.5 |
| Length reduction over two | | | | 2.1 | | 0.6 |
| actives separately (cm) and | | | | 22% | | 10% |
| additional reduction over | | | | | | |
| additive effect (%) | | | | | | |

Efficacies of active ingredient combinations are more precisely determined, for example, by the Colby formula (S. R. Colby, Calculating Synergistic and Antagonistic Response of Herbicide Combinations, Weeds, 15, p. 20-22). The additive effect of experiments B and C, in comparison with Example 1 were 14.0 (additive) vs 17.7 (combination), while these of C and D in comparison with Example 2 were 8.9 (additive), and 10.0 for the synergistic combination, resp 26% and 12% increase in comparison to the additive effect.

These results show that the length of the rapeseed plants was reduced more, than the additive effect of the two actives.

The invention has been described by reference to certain embodiments discussed above. It will be recognized that these embodiments are susceptible to various modifications and alternative forms well known to those of skill in the art without departing from the scope of the invention. Accordingly, although specific embodiments have been described, these are examples only and are not limiting upon the scope of the invention, which is defined in the accompanying claims.

1. Water based spraying liquid suitable for spraying plants, wherein the liquid comprises water and a suitable amount of the plant growth regulator prohexadione optionally in combination with trinexapac-ethyl, and at least one fungicide chosen from the group of prothioconazole, metconazole, difenoconazole, paclobutrazole, triticonazole, tebuconazole, azoxystrobin, picoxystrobin, boscalid and penthiopyrad;
wherein the amount of growth regulator is between 20 and 400 g per hectare
and wherein the amount of fungicide is between 20 and 500 g/ha

2. Water based spraying liquid according to claim 1, wherein the at least one fungicide is chosen from the group comprising prothioconazole, azoxystrobin, picoxystrobin, boscalid and penthiopyrad.

3. Water based spraying liquid according to claim 2, wherein the fungicide comprises prothioconazole in an amount between 50 and 200 g/ha.

4. Water based spraying liquid according to any one of claims 1-3, wherein at least two fungicides are combined with prohexadione optionally combined with trinexapac-ethyl, wherein the fungicide comprises prothioconazole and one of metconazole, difenoconazole, paclobutrazole, triticonazole, tebuconazole, azoxystrobin, picoxystrobin, boscalid and penthiopyrad.

5. Water based spraying liquid according to any one of claims 1-4, wherein the growth regulator comprises prohexadione-calcium.

6. Water based spraying liquid according to any one of the preceding claims, wherein the amount of growth regulator is between 50 and 200 g per hectare and wherein the amount of fungicide is between 30 and 300 g/ha, and wherein the ratio between the growth regulator and the fungicide is between 1:0.6 to 1:4 preferably 1:1 to 1:3.

7. Water based spraying liquid according to any one of the preceding claims, wherein the amounts of said growth regulator and said fungicide are such that a synergistic effect on stem length retardation is achieved.

8. Spraying liquid according to any one of the preceding claims, wherein the spraying liquid further comprises additionally, one or more growth regulators, fungicides, metal compounds, penetrating agents, and/or one or more jasmonates.

9. Spraying liquid according to any one of the preceding claims, wherein the liquid further comprises at least one of an aliphatic amino compound, an ammonium salt or a carboxylic acid.

10. Method for treating plants with at least one growth regulator and at least one fungicide, wherein a water based spraying liquid according to any one of the preceding claims is sprayed on plants in an amount of about 80 L to about 500 L per hectare, preferably 100 L-400 L per hectare.

11. Method according to claim 10, wherein the plants are broad acre crop, preferably chosen from rape seed or cereal, wherein preferably, if the crop is cereal, the cereal is chosen from barley, oat, wheat, rye, triticale, grain or corn.

12. Kit of parts for use in the method according to any one of the preceding claims, wherein a growth regulator is provided in a first concentrated form, and a fungicide is provided in a second concentrated form, wherein the relative amounts of actives in the kit are adapted to provide the amounts described in any one of the preceding claims.

13. A composition, preferably granular composition, comprising
the plant growth regulator prohexadione, optionally in combination with trinexapac-ethyl;
at least one fungicide chosen from the group comprising prothioconazole, metconazole, difenoconazole, paclobutrazole, triticonazole, tebuconazole, azoxystrobin, picoxystrobin, boscalid and penthiopyrad
wherein the amount of said growth regulator is about 4 wt % or more and about 50 wt % or less, and the amount of fungicide is about 2 wt % or more and about 50 wt % or less
optionally at least one of a binder, a dispersion agent, and anticacking agent

14. A liquid dispersion comprising:
the plant growth regulator prohexadione optionally in combination with trinexapac-ethyl;
at least one fungicide chosen from the group comprising prothioconazole, metconazole, difenoconazole, paclobutrazole, triticonazole, tebuconazole, azoxystrobin, picoxystrobin, boscalid and penthiopyrad;
an organic hydrophobic carrier chosen from a vegetable oil;
wherein more than about 90% of the particles of said growth regulator have a particle size of between 1-7 μm;
wherein the fungicide is dissolved or dispersed in the liquid, and if dispersed has a particle size of between 1-7 μm;
wherein the dispersion further comprises an emulsifier which stabilizes the dispersion in the organic carrier, and wherein the emulsifier is non-ionic, and comprises at least one fatty acid group, at least one polyethoxy group, or more than one ethoxy group, and at least one polyol, wherein the fatty acid and polyol may be combined in hydroxyl-fatty acid;
at least one additive to reduce settling
wherein the dispersion is essentially water free, wherein preferably, the growth regulator comprises prohexadione-Ca salt and the fungicide comprises prothioconazole, and wherein preferably the amount of said growth regulator is about 4 wt % or more and about 40 wt % or less, and the amount of fungicide is about 2 wt % or more and about 40 wt % or less.

15. Use of a fungicide chosen from the group consisting of prothioconazole, metconazole, difenoconazole, paclobutrazole, triticonazole, tebuconazole, azoxystrobin, picoxystrobin, boscalid and penthiopyrad to enhance the growth regulation effect of prohexadione.
